(19) United States
(12) Patent Application Publication
(10) Pub. No.: US 2021/0001710 A1
(43) Pub. Date: Jan. 7, 2021

(54) Spherical Drive Wheel

(71) Applicant: Manitou Equipment America, LLC, West Bend, WI (US)

(72) Inventor: Erhardt Wowerat, Oakfield, WI (US)

(21) Appl. No.: 16/904,283

(22) Filed: Jun. 17, 2020

Related U.S. Application Data
(60) Provisional application No. 62/870,274, filed on Jul. 3, 2019.

(51) Int. Cl. B60K 7/00; B62D 57/00; B60B 19/14; B62D 11/04

(52) U.S. Cl. CPC B60K 7/0007; B62D 57/00; B60K 2007/003; B62D 11/04; B60B 19/14

(57) ABSTRACT

A two-axis spherical wheel or ball-wheel is provided wherein hemispheres (or spherical caps) rotate independently about a transverse or spherical axis and rotate dependently about an axial or longitudinal axis. In this way, a ball-wheel supports a vehicle chassis and drives (e.g., translates or rotates) the vehicle in any direction. Systems of ball-wheels are also disclosed. Two, three, four, or more ball-wheels can be joined in a system to support, translate, and/or rotate a vehicle without requiring the vehicle to turn. The ball-wheels include protective features to prevent debris from entering a drive system. Protective features may include springs and/or dampers to absorb impact forces on the vehicle chassis. Orienting the ball-wheels about a center point of the vehicle chassis enhances support and control of the vehicle.

### CROSS-REFERENCE TO RELATED PATENT APPLICATION

The present application claims the benefit of and priority to U.S. Provisional Application No. 62/870,274 filed on Jul. 3, 2019, which is incorporated herein by reference in its entirety.

### BACKGROUND OF THE INVENTION

The present invention generally relates to the field of wheels and drive systems. The present invention relates specifically to a spherical drive wheel. Conventional wheels rotate about a central axis in one direction. In other words, the wheel has one degree of freedom to rotate. Generally, the wheel can rotate forward and backward along that single directional degree of freedom. The present invention relates to a ball-wheel and drive system that enable additional degrees of rotational freedom.

### SUMMARY OF THE INVENTION

One embodiment of the invention relates to a ball-wheel and wheel drive system. The ball-wheel and drive system include first and second spherical caps. The first spherical cap includes a first apex or pole on the first spherical cap, a first base of the first spherical cap including a first center opposite the first pole, and a first motor coupled to the first center and configured to rotate the first spherical cap. The second spherical cap includes a second pole on the second spherical cap, a second base of the second spherical cap including a second center opposite the second pole. The second base of the second spherical cap is parallel and opposite the first base of the first spherical cap to form a spherical zone. A spherical axis is defined through the first pole and the second pole. A second motor is coupled to the second center and configured to rotate the second spherical cap. A shaft is coupled to the first center and the second center. The shaft defines an axial axis. The first motor is configured to rotate the first spherical cap about the spherical axis independent from the second motor that is configured to rotate the second spherical cap about the spherical axis. A third motor is coupled to the shaft and rotates the first spherical cap and the second spherical cap dependently about the axial axis.

Another embodiment of the invention relates to a two-axis ball-wheel and drive system. The system includes a hollow, spherical wheel. The spherical wheel includes first and second equal halves each having a maximum diameter. The maximum diameters are equal, and each has a center. A first plane intersects the first half of the spherical wheel at the maximum diameter of the first half of the spherical wheel. A second plane intersects the second half of the spherical wheel at the maximum diameter of the second half of the spherical wheel. A distance spaces the first and second planes. A longitudinal axis extends perpendicular to the first and second planes and intersects the first and second planes at the centers. A transverse axis intersects the longitudinal axis between the first and second planes. A rotatable shaft, extending along the longitudinal axis, includes an axial bore. A first motor rotates an output shaft within the axial bore of the rotatable shaft about the longitudinal axis. Rotation of the output shaft is transformed into rotation about a transverse axis. The first motor is configured to rotate the first half of the spherical wheel about the transverse axis. A second motor rotates an output shaft within the axial bore of the rotatable shaft about the longitudinal axis. Rotation of the output shaft is transformed into rotation about the transverse axis. The second motor is configured to rotate the second half of the spherical wheel about the transverse axis independent of the rotation of the first half of the spherical wheel about the transverse axis. A third motor is configured to rotate the rotatable shaft and rotate the first half of the spherical wheel and the second half of the spherical wheel dependently about the longitudinal axis.

Another embodiment of the invention relates to a vehicle. The vehicle includes a first ball-wheel, a second ball-wheel, and a third ball-wheel. The first ball-wheel includes a first spherical cap coupled to a second spherical cap at a first center of the first and second spherical caps. The first and the second spherical caps dependently rotate about a first longitudinal axis and are configured to rotate independently about a first transverse axis that is perpendicular to the first longitudinal axis and passes through a first pole of the first spherical cap and a second pole of the second spherical cap. The second ball-wheel includes a third spherical cap coupled to a fourth spherical cap at a second center of the third and fourth spherical caps. The third and fourth spherical caps dependently rotate about a second longitudinal axis and are configured to rotate independently about a second transverse axis that is perpendicular to the second longitudinal axis and passes through a third pole of the third spherical cap and a fourth pole of the fourth spherical cap. The third ball-wheel includes a fifth spherical cap coupled to a sixth spherical cap at a third center of the fifth and sixth spherical caps. The fifth and sixth spherical caps dependently rotate about a third longitudinal axis and are configured to rotate independently about a third transverse axis that is perpendicular to the third longitudinal axis and passes through a fifth pole of the fifth spherical cap and a sixth pole of the sixth spherical cap. The first center of the first and second spherical caps, the second center of the third and fourth spherical caps, and the third center of the fifth and sixth spherical caps are located on a circle such that a diameter of the circle passes through the first center of the first and second spherical caps, the second center of the third and fourth spherical caps, and the third center of the fifth and sixth spherical caps.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a ball-wheel and drive system assembly, according to an exemplary embodiment.

FIG. 2 is a geometric representation of a sphere to illustrate the geometrical features of a spherical ball-wheel.

FIG. 3 is an outer surface or exterior of a spherical cap of a ball-wheel.

FIG. 4 is an inner surface or interior of a spherical cap of a ball-wheel.

FIG. 5 is an inner support bracket of the spherical cap shown in FIG. 1.

FIG. 6 is a partial assembly of the ball-wheel of FIG. 1, showing the inner and outer surfaces coupled with the inner support bracket, according to an exemplary embodiment.

FIG. 7 shows the partial assembly of FIG. 6 with a seal coupled to the spherical cap, according to an exemplary embodiment.

FIG. 8 is a two-shaft motor, according to an exemplary embodiment.

FIG. 9 is a mounting bracket or housing for the two-shaft motor shown in FIG. 8.

FIG. 10 shows the two-shaft motor of FIG. 8 coupled to the housing of FIG. 9 on a motor mounting frame or shaft, according to an exemplary embodiment.

FIG. 11 is a motor mounting frame or shaft that couples to two spherical caps, according to an exemplary embodiment.

FIG. 12 is an outer frame that couples to the shaft of FIG. 11 to support a ball-wheel and drive system assembly, according to an exemplary embodiment.

FIG. 13 is a partial assembly of one spherical cap of the ball-wheel and drive system coupled to the shaft and outer frame, according to an exemplary embodiment.

FIG. 14 is the partial assembly of FIG. 13 where the spherical cap includes a protective bracket for debris protection, according to an exemplary embodiment.

FIG. 15 is the partial assembly of FIG. 13 with a spring loaded protective bracket for support and debris protection, according to an exemplary embodiment.

FIG. 16 is a side view of a ball-wheel assembly showing the rotation of the ball-wheel about a spherical or transverse axis to drive the ball-wheel system forward.

FIG. 17 is the side view of FIG. 16 showing the rotation of the ball-wheel about a transverse axis to drive the system back or rearward.

FIG. 18 a rear view of the ball-wheel of FIG. 16 showing the rotation of the ball-wheel about an axial or longitudinal axis to drive the system to the right.

FIG. 19 is a rear view of the ball-wheel of FIG. 16 showing the rotation of the ball-wheel about the longitudinal axis to drive the system to the left.

FIG. 20 is a top view of the ball-wheel in FIGS. 16-19 showing how the rotations shown in FIGS. 16-19 of the spherical caps about the spherical axis and axial axis selectively drives the spherical ball-wheel in any direction.

FIG. 21 is a cross-sectional view of a ball-wheel and another drive system with three independent motors external to the spherical cap, according to an exemplary embodiment.

FIG. 22 is a perspective view of a one ball-wheel system to drive a vehicle showing a central ball-wheel and supporting casters, according to an exemplary embodiment.

FIG. 23 is a perspective view of a two ball-wheel system to drive a vehicle showing two ball-wheels and two supporting casters, according to an exemplary embodiment.

FIG. 24 is a perspective view of a three ball-wheel system to drive a vehicle showing three ball-wheels oriented radially from a central location, according to an exemplary embodiment.

FIG. 25 is a perspective view of a four-ball-wheel system to drive a vehicle, according to an exemplary embodiment.

FIG. 26 is a top view of the four-ball-wheel system shown in FIG. 25 and illustrating a central radius that passes through the center of all four-ball-wheels, according to an exemplary embodiment.

FIG. 27 is an isometric view of a three ball-wheel vehicle, according to an exemplary embodiment.

FIG. 28 is a top plan view of the three ball-wheel vehicle of FIG. 27.

FIG. 29 is a front plan view of the three ball-wheel vehicle of FIG. 27.

FIG. 30 is a side plan view of the three ball-wheel vehicle of FIG. 27.

FIG. 31 is a back plan view of the three ball-wheel vehicle of FIG. 27.

FIG. 32 is an isometric view of a four-ball-wheel vehicle, according to an exemplary embodiment.

FIG. 33 is a top plan view of the four-ball-wheel vehicle of FIG. 32.

FIG. 34 is a front plan view of the four-ball-wheel vehicle of FIG. 32.

FIG. 35 is a side plan view of the four-ball-wheel vehicle of FIG. 32.

FIG. 36 is a back plan view of the four-ball-wheel vehicle of FIG. 32.

### DETAILED DESCRIPTION

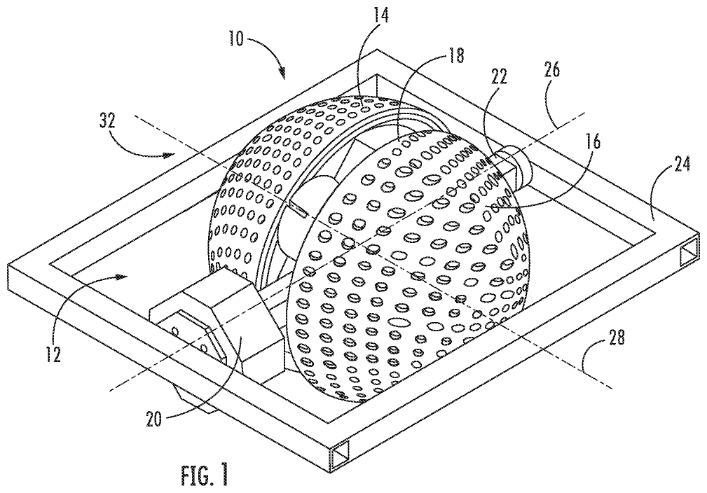

FIG. 1 is a perspective view of a two-axis spherical wheel or ball-wheel 10 and wheel drive assembly or drive system 12, according to an exemplary embodiment. The ball-wheel 10 includes a first spherical cap 14 and a second spherical cap 16 (e.g., hemispheres). An internal support, frame, or inner support bracket 18 provides structural support for each spherical cap 14 and 16. Ball-wheel 10 includes drive system 12 with one or more dependent (or independent) motors 20 to rotate spherical caps 14 and 16 dependently or independently. A dependent motor 20 rotates both spherical caps in the same direction, speed, and distance. An independent motor, described in greater detail below, is in general configured to rotate one spherical cap 14 a different direction, speed, and/or distance than a second spherical cap 16.

For example, dependent motor 20 couples to and rotates an inner mounting bracket or shaft 22 that rotates both spherical caps 14 and 16 about the shaft 22. Shaft 22 is rotatably supported by an external or surrounding frame 24. As shaft 22 rotates, spherical caps 14 and 16 dependently rotate about the shaft 22 within outer frame 24. Frame 24 provides mounting locations to couple ball-wheel 10 and drive system 12 to a vehicle. For example, spherical caps 14 and 16 are greater than hemispheres. Alternatively, spherical caps 14 and 16 are less than hemispheres. In one embodiment, spherical caps 14 and 16 are equal half spheres or hemispheres.

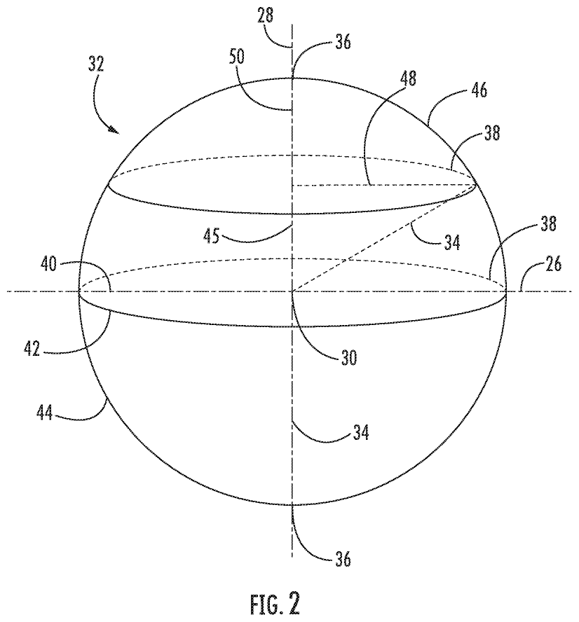

With reference to FIGS. 1 and 2, an axial or longitudinal axis 26 extends through shaft 22. A spherical or transverse axis 28 extends orthogonally to the longitudinal axis 26 at a center 30 of a sphere 32, or the spherical shape formed from coupling two spherical caps 14 and 16. A sphere radius 34 extends from center 30 to opposite poles 36. When radius 34 is perpendicular to a base 38 that is co-planar with center 30, the radius intersects the sphere 32 or spherical cap 14 or 16 at a pole 36. In other words, a diameter 40 that passes through center 30 and is orthogonal to base 38 passes through the poles 36 of each spherical cap 14 and 16. Each spherical cap 14 and 16 rotates dependently about longitudinal axis 26 and independently about transverse axis 28. In other words, spherical cap 14 can rotate Counter Clock Wise (CCW) about transverse axis 28 while second spherical cap 16 rotates Clock Wise (CW), and both hemispheres rotate together dependently in either direction (e.g., CW or CCW) about longitudinal axis 26.

FIG. 2 defines a spherical geometric construction, or sphere 32 that illustrates spherical geometry similar that is the same or similar to the geometry of a spherical ball-wheel 10. Sphere 32 is a collection of equidistant points from center 30. Sphere 32 includes longitudinal axis 26 passing through center 30 and parallel to base 38 and a transverse axis 28 that passes through center 30 orthogonal to base 38. For example, center 30 has a radius 34 which extends from center 30 in all directions to define a spherical surface with each point equidistant from center 30 of sphere 32. Radius 34 defines two poles 36 located on opposite ends of sphere 32 and collinear with center 30. In other words, two collinear radii 34 form a diameter 40 that is orthogonal to base 38 and passes through center 30 to terminate at two poles 36 on opposite ends of sphere 32. Diameter 40 defines a maximum diameter 40 of base 38. When base 38 includes the maximum diameter 40 through center 30, base 38 is known as a great circle 42. Sphere 32 can be hollow or solid and may be divided into one or more sections (e.g., spherical caps, spherical segments of one base, a spherical segment of two bases, etc.). A spherical cap 14 or 16 may include an offset 45 that is less than radius 34 and parallel to great circle 42. For example, sphere 32 may be divided along a plane through center 30 that is equidistant from the pair of poles 36 forming great circle 42. Great circle 42 is defined as the largest diameter cross-section of sphere 32. The collection of all lines or diameters 40 on a plane through center 30 defines great circle 42, and a line (e.g., diameter 40) that passes through center 30 and is perpendicular to great circle 42 terminates at and defines poles 36. In this configuration, sphere 32 defines two equal hemispheres 44 on either side of the great circle 42 through center 30 that have bases 38 at the great circle 42.

As shown, base 38 need not pass through center 30. For example, base 38 is parallel to the plane formed by great circle 42 but offset 45 from great circle 42 to form a spherical cap or spherical segment 46 with one base 38. Spherical segment 46 with one base 38 is defined as the segment 46 of sphere 32 that extends from base 38 to one of the two poles 36. Spherical segment 46 with one base 38 has a second radius 48 and a height 50. Second radius 48 is defined at a plane offset 45 from great circle 42 and is measured along the offset 45 plane or base 38. Height 50 is the radius 34 of sphere 32 minus the offset 45 distance. By definition, second radius 48 is less than radius 34, but height 50 may be less than, equal to, or greater than radius 34.

In other words, when the spherical segment 46 with one base 38 has a base 38 equal to the great circle 42, the spherical segment 46 with one base 38 is a half sphere, called a hemisphere 44. In this application, spherical segment 46 with one base 38 (e.g., spherical caps 14 and 16) refers to any spherical segment 46 with a base 38. In general, a spherical segment 46 with one base 38 has a pole 36 opposite the center 30 of base 38. Spherical segment 46 with one base 38 refers to a spherical segment 46 with a base 38 that is less than or equal to the great circle 42 and a height 50 that is less than, equal to, or greater than radius 34. Hemisphere 44 refers to one half of sphere 32 with a base 38 equal to the great circle 42. Spherical segments 46 with one base 38 may also have a height 50 greater than radius 34, but the second radius 48 in such applications will remain less than spherical radius 34. Spherical segments 46 can include two bases 46. Geometric spherical segments 46 define the shape of a hollow or solid spherical cap 14 and/or 16 used to construct ball-wheel 10.

First and second spherical caps 14 and 16 each include a pole 36 opposite center 30 of base 38. Center 30 is on the base 38 opposite pole 36. First and second spherical caps 14 and 16 are oriented on shaft 22 such that first base 38 of first spherical cap 14 is parallel and opposite second base 38 of second spherical cap 16. Collectively, spherical caps 14 and 16 form a spherical zone or sphere 32. Sphere 32 includes a spherical or transverse axis 28 defined through first and second poles 36 of the first and second spherical caps 14. Center 30 of the spherical zone is created by coupling the spherical caps 14 and 16 and is located on the transverse axis 28 at center 30 of the spherical zone created from coupling spherical caps 14 and 16.

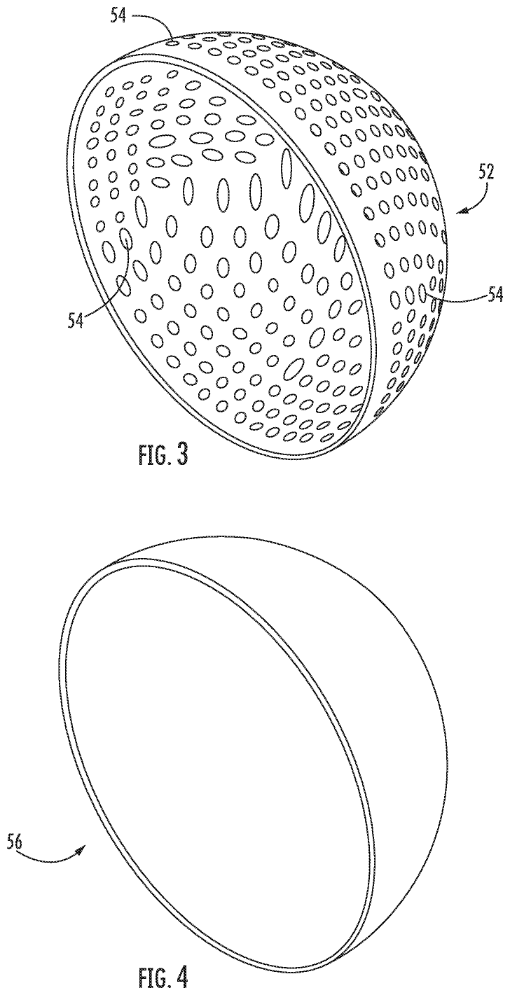

FIG. 3 shows an outer surface, outer traction layer, or exterior 52 of spherical cap 14 and/or 16 that forms ball-wheel 10. For convenience only, reference below is made to spherical cap 14, although it is to be understood that the description of spherical cap 14 also applies to spherical cap 16. Exterior 52 includes tractive features 54. Tractive features 54 may be projections and/or holes that facilitate gripping a surface (e.g., by increasing a coefficient of friction between exterior 52 and the surface). Tractive features 54 may include different materials on exterior 52. For example, a particular material is selected as a tractive feature 54 for an outdoor environment (e.g., dirt) and another tractive feature 54 is selected for an indoor environment. For example, tractive features 54 include masticated rubber, thermoplastic elastomers, co-polymer polypropylene, cross-linked polyethylene, neoprene, EPDM (ethylene propylene diene terpolymer), SBR (styrene butadiene rubber) blends, polyurethanes, polyureas, and/or aliphatic type compounds. In embodiments, the tractive materials are a composite compound including mixed materials. The stiffness of exterior 52 and/or sphere cap 14 may also be selected for a particular environment. Exterior 52 of spherical cap 14 may be replaceable so that tractive features 54 can be selected and interchanged to enhance the designed friction, stiffness, and/or deflection of ball-wheel 10 for a particular operating environment (e.g., mud, gravel, rock, asphalt, dirt, concrete slab, indoors, etc.).

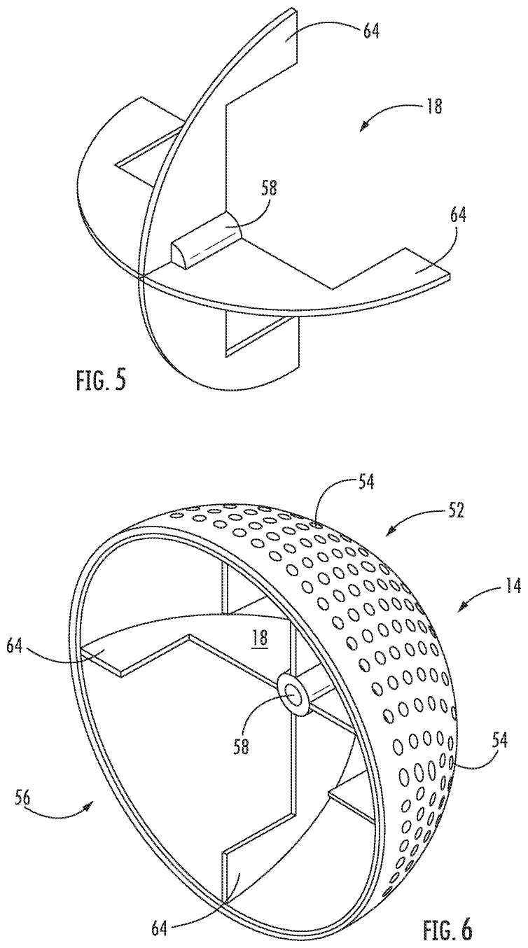

FIG. 4 is an inner surface, rigid inner layer, or interior 56 of spherical cap 14 forming ball-wheel 10, as shown in FIG. 1. Interior 56 provides structural integrity and rigidity to spherical cap 14. Exterior 52 materials provide traction but the material selected provides independent structural strength to support ball-wheel 10. Interior 56 is formed from a rigid material (e.g., metal or vulcanized rubber) and/or includes internal support bracket 18 (FIG. 5) to support the loads generated on exterior 52. For example, exterior 52 and interior 56 are coupled by welding, adhesives, and/or fasteners to support external loads. Exterior 52 and interior 56 each include materials of different hardness. For example, exterior 52 includes a softer material (e.g., lower Rockwell hardness) to absorb vibration and shock, and interior 56 includes a harder material (e.g., higher Rockwell hardness) to provide structural strength to spherical cap 14. The load rating and speed of the intended use for ball-wheel 10 determines the materials and sizes of exterior 52 and interior 56 of spherical cap 14. For example, a tractive sphere cap or exterior 52 includes formations and/or tractive features 54 to provide traction for the ball-wheel 10, and the inner sphere or interior 56 includes a rigid material to provide structural support to ball-wheel 10.

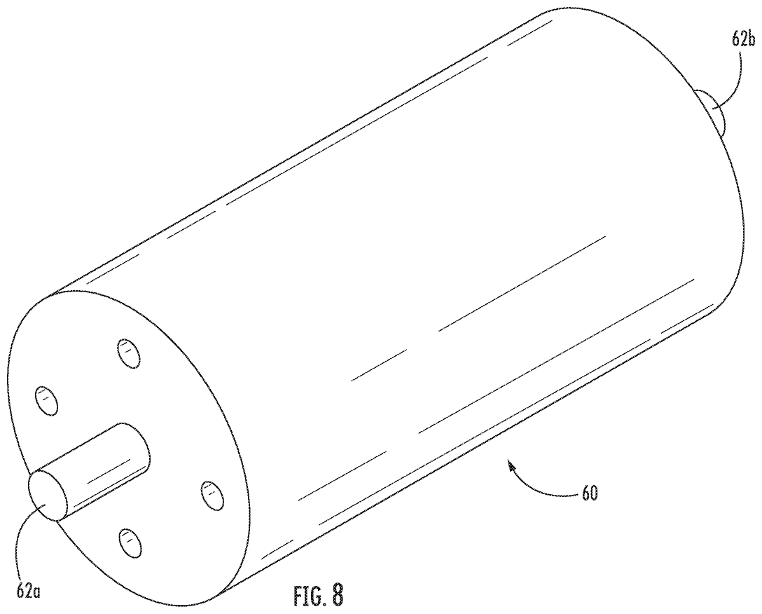

FIG. 5 shows an inner support bracket 18 with bushings 58 to rigidly couple to spherical cap 14. Inner support bracket 18 supports spherical cap 14 and secures, mounts, and/or couples spherical cap 14 to an internal or independent motor 60 or shaft 62 (FIG. 8). Inner support bracket 18 includes bushing 58 formed at the junction of two frames 64 that couple to form inner support bracket 18. Frames 64 can have the same or similar shapes. Bushing 58 rigidly couples the inner support bracket 18 to a motor 60 output shaft 62 (FIG. 8). A first inner support bracket 18, e.g., manufactured from a frame 64. As shown in FIG. 5, two or more frames 64 couple spherical cap 14 to a first motor 60a or a first output shaft 62a. A second inner support bracket 18 couples spherical cap 16 to a second motor 60b or a second output shaft 62b. (FIG. 8) In this way, each motor 60a and 60b independently rotates an output shaft 62a or 62b and/or spherical caps 14 and 16. In other embodiments, a two-shaft motor 60 has two dependent output shafts 62 to rotate spherical caps 14 and 16 dependently about transverse axis 28.

Bushing 58 couples to and rigidly secures to output shaft 62 (FIGS. 8) of internal motor 60. In various embodiments, bushing 58 could have a through hole and/or internal or external threads. For example, if bushing 58 includes internal threads, a bolt passes through apex or pole 36 of spherical cap 14 to couple bushing 58 to output shaft 62. Bushing 58 includes external threads and an external nut couples bushing 58 to output shaft 62. For example, bushing 58 includes a keyway and set-screw or a D-shaft 62 on set screws that rigidly receive the motor 60 output shaft 62 to rotate inner support bracket 18. In another example, bushing 58 includes a tapered hole at the apex of spherical cap 14 that secures a non-circular shaft 62 (e.g., “D”-shaped, hexagonal, gear and sprocket, etc.) to rotate bushing 58 coupled to spherical cap 14. As inner support bracket 18 rotates sphere cap 14 (e.g., exterior 52 and interior 56), spherical caps 14 and 16 of ball-wheel 10 rotate independently. In this way, internal motor(s) 60 couple to and rotate spherical caps 14 and 16 independently.

FIG. 6 shows a partial assembly of exterior 52, interior 56, and inner support bracket 18 of FIGS. 2-4, according to an exemplary embodiment. This view shows how bushing 58 transmits the output shafts 62 rotation from motor 60 to inner support bracket 18, which independently rotates one spherical cap 14 or 16 of ball-wheel 10.

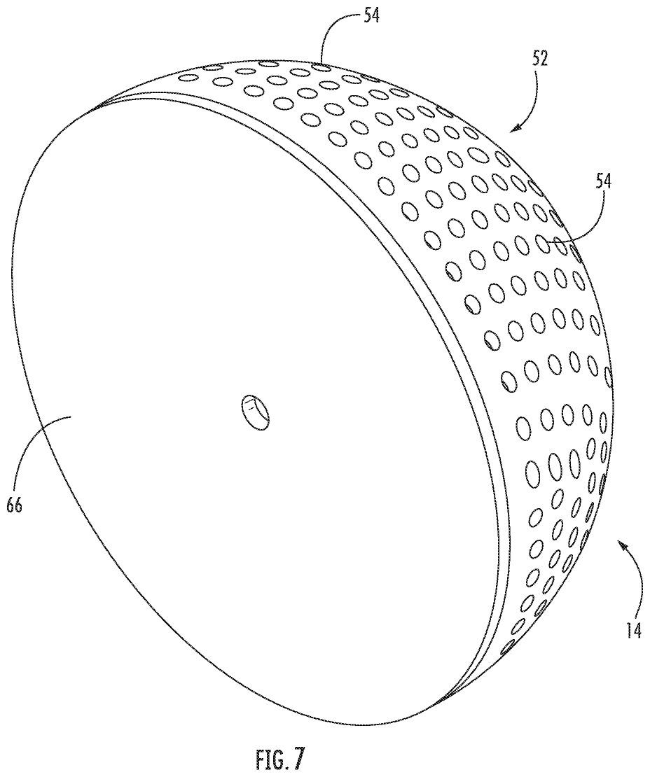

FIG. 7 shows the partial assembly of FIG. 6 with a seal 66 coupled to spherical cap 14 (or spherical cap 16), according to an exemplary embodiment. Seal 66 couples to a circumference of base 38 to prevent debris (e.g., dirt, chemicals, water, etc.) from penetrating inner bracket 18 or interior 56 of spherical wheel 14. As shown in FIG. 7, seal 66 forms a base 38 (FIG. 2) of spherical cap 14 and/or 16. A first seal 66 is coupled to a first base 38 of first spherical cap 14 and a second seal 66 is coupled to a second base 38 of second spherical cap 16.

FIG. 8 is a two-shaft internal motor 60 (e.g., a motor with two dependent shafts 62a and 62b). Motor 60 rotates spherical caps 14 and 16 dependently. For example, a first motor 60a couples to a first center 30 of spherical cap 14 and a second motor 60b couples to a second center 30 of second spherical cap 16. In this configuration, first motor 60a rotates first spherical cap 14 about spherical axis 28 independent from the rotation of second motor 60 coupled to second spherical cap 16. In other embodiments, a single-shaft motor 60 has a dependent output shaft 62 to rotate spherical caps 14 and 16 dependently about transverse axis 28. For example, internal motor 60 rotates output shaft 62 dependent on the rotation at an opposite side to rotate spherical caps 14 and 16 dependently about transverse axis 28.

As illustrated in FIG. 21, first and second independent motors 60a and 60b, are located within first and second spherical caps 14 and 16, respectively. A third dependent motor 20 is located on frame 24 along longitudinal axis 26 and rotates shaft 22. For example, dependent motor 20 and independent motor(s) 60 are disposed outside of the spherical zone from coupling spherical caps 14 and 16. Motor 20 rotates output shaft 22 about longitudinal axis 26, and motor 60 rotates output shafts 62 that couple to spherical caps 14 and 16 to rotate about the spherical or transverse axis 28.

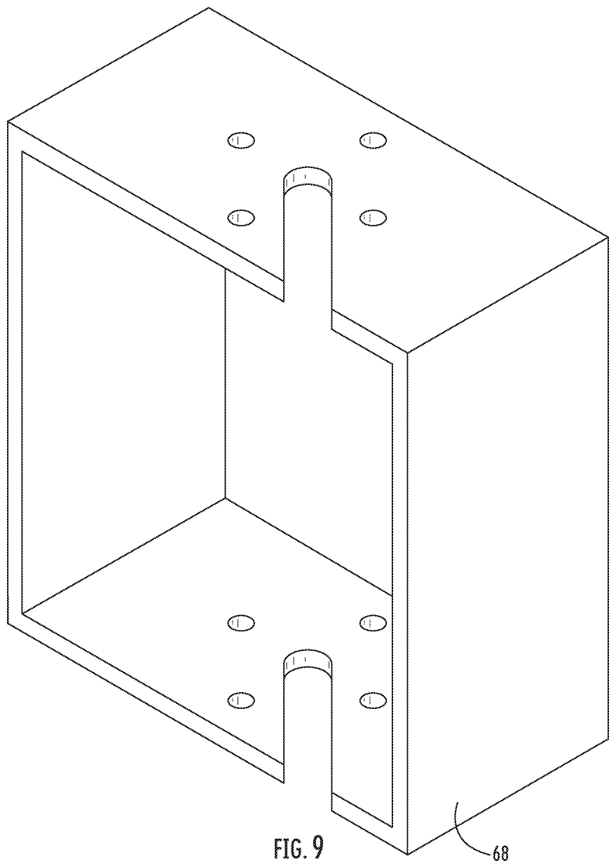

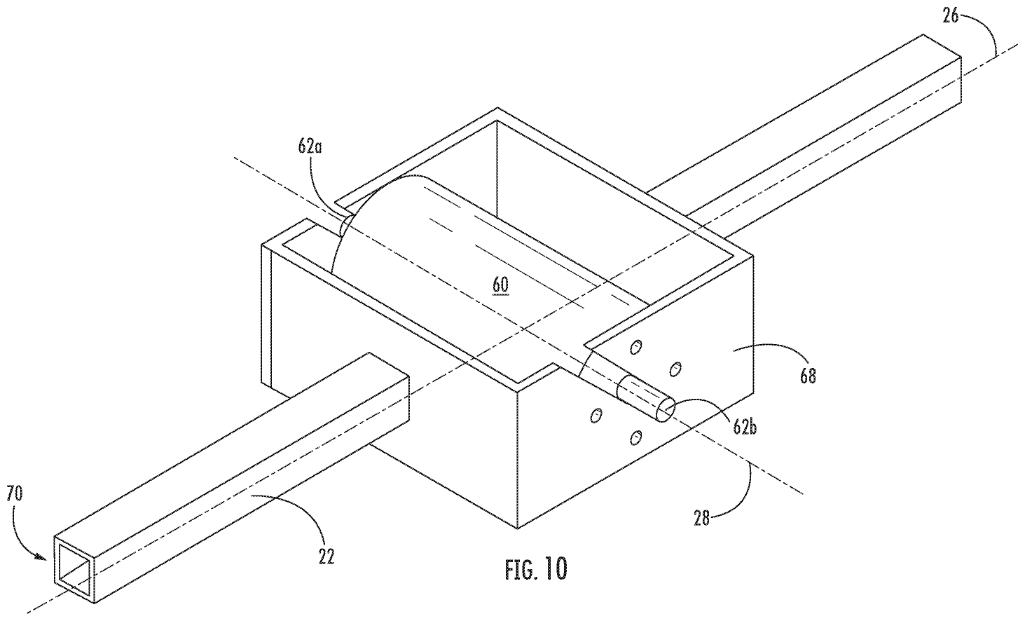

FIG. 9 illustrates a mounting bracket or housing 68 for the two-shaft motor 60 shown in FIG. 8, and FIG. 10 shows motor 60 coupled to housing 68. The assembly shown in FIG. 10 includes a motor mounting frame or shaft 22 for a two-shaft 62a and 62b motor 60 that extends along transverse axis 28. Shaft 22 includes a bore 70. Bore 70 passes through shaft 22 from one end to the opposite end of shaft 22, for example to receive an output shaft 22 and/or 62 inside bore 70. One or more motors 20 and 60 can rotate and/or surround shaft 22.

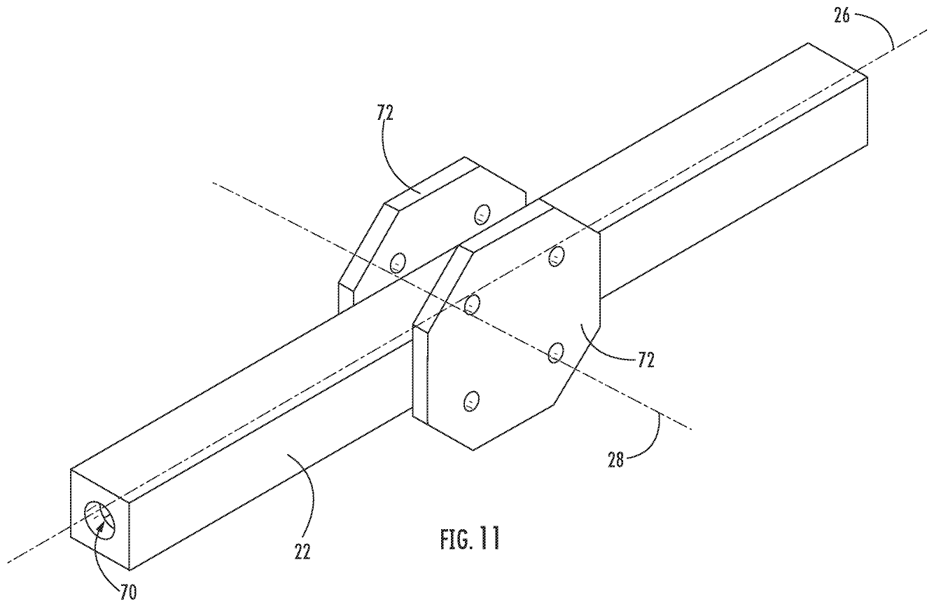

FIG. 11 is another embodiment of shaft 22 that couples to two independent motors 60a and 60b to each spherical cap 14 and 16, respectively. In this configuration, shaft 22 dependently couples to each motor 60a and 60b and each motor 60a and 60b independently rotates each spherical cap 14 and 16. For example, two single-shaft motors 60a and 60b couple to motor mount 72 and individually to spherical caps 14 and 16 to independently rotate first and second spherical caps 14 and 16 about transverse axis 28. Shaft 22 is coupled to a third or dependent motor 20 that rotates shaft 22 about longitudinal axis 26 and motor 60 dependently rotates spherical caps 14 and 16 coupled to motor mount 72 dependently about transverse axis 28. In this configuration, the combination of longitudinal and transverse dependent rotations direct the motion of spherical ball wheel 10 in a desired direction.

FIG. 12 is an outer frame 24 that couples to shaft 22 to support ball-wheel 10 and drive system 12. Shaft 22 couples to dependent motor 20 at motor mount 72 at one end of outer frame 24 and a bearing 74 at an opposite end of outer frame 24. Third motor 20 rotates shaft 22 within outer frame 24 to rotate spherical caps 14 and 16 dependently around longitudinal axis 26. Frame 24 couples to shaft coupled to spherical caps 14 and 16, such that shaft 22 is rotatably coupled within frame 24.

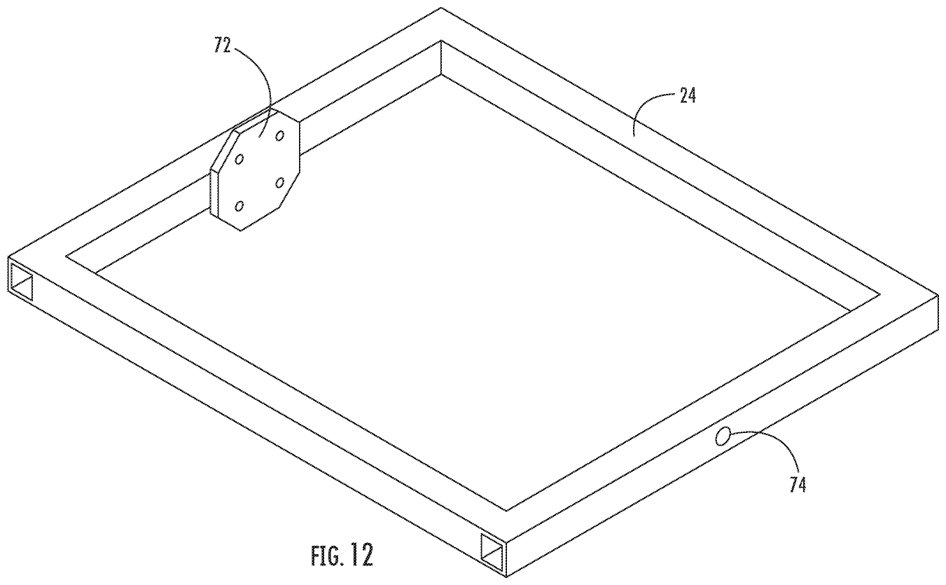

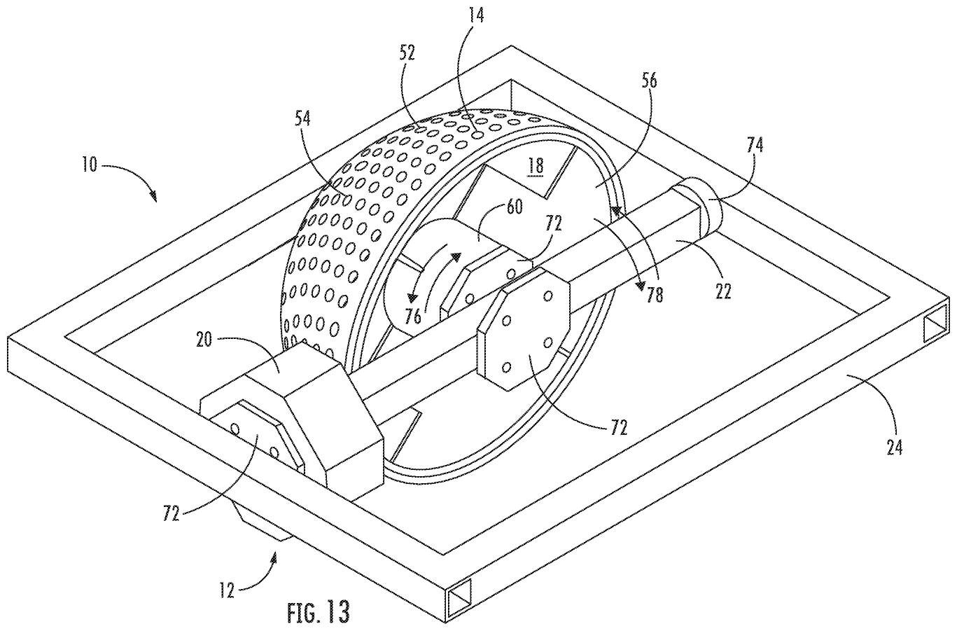

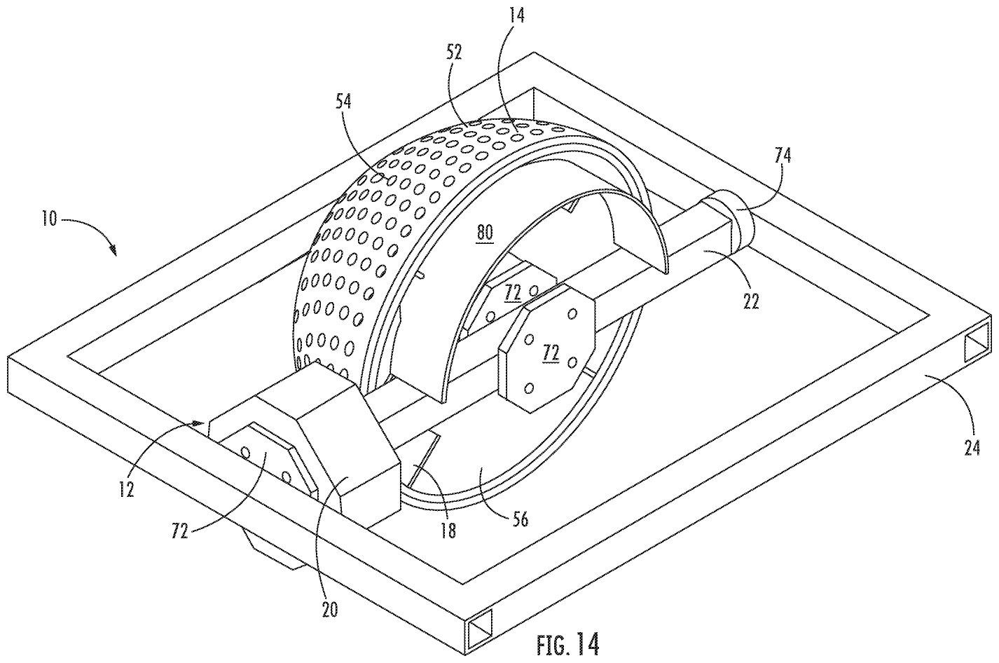

FIG. 13 shows a partial assembly of one spherical cap 14 of ball-wheel 10 coupled to shaft 22 and outer frame 24. Motor 60a is coupled to a first motor mount 72 on shaft 22 and rotates spherical cap 14 about transverse axis 28 in the direction of arrows 76 independent of the rotation of spherical cap 16 coupled to the opposite motor mount 72. The third motor 20 couples to shaft 22 and rotates both spherical caps 14 and 16 dependently about longitudinal axis 26 in the direction of arrows 78. FIG. 14 depicts a partial assembly of FIG. 13 with a protective bracket 80 for protection from debris. Protective bracket 80 is disposed between first and second spherical caps 14 and 16 to block foreign debris from entering the interior 56 of ball-wheel 10.

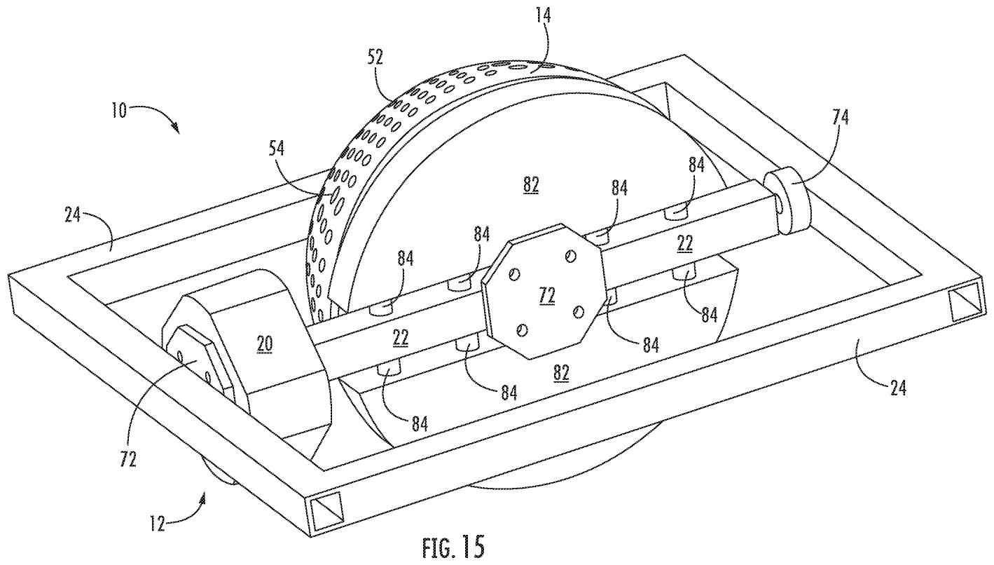

FIG. 15 shows a partial assembly of FIG. 13 with a spring loaded protective bracket 82 for support and debris protection. The spring-loaded protective bracket 82 is similar to the seal 66. Whereas seal 66 couples to base 38 (FIG. 2) of sphere caps 14 and 16, spring loaded protective bracket 82 couples to shaft 22 and is adjacent to base 38. Protective bracket includes springs 84 that couple an upper protective bracket to a lower protective bracket 82 about shaft 22 to provide support to ball-wheel 10. Springs 84 bias protective brackets 82 surrounding shaft 22 and enhance support between the spherical caps 14 and 16 as ball-wheel 10 rolls.

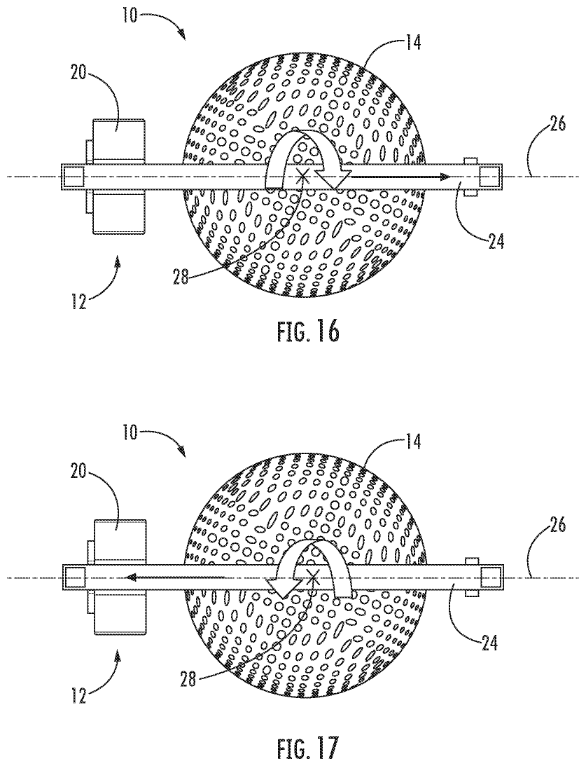

With reference to FIGS. 16-17, a side view of a ball-wheel 10 and drive system 12 is illustrated to show how the rotation of the ball-wheel 10 in a CW direction (FIG. 16) moves the ball-wheel 10 right. FIGS. 16-17 show longitudinal axis 26 in the plane of the page and transverse axis 28 into and out of the page. Outer frame 24 moves to the right as ball-wheel 10 assembly rotates CW to drive the ball-wheel 10 and drive system 12 forward (e.g., rightward in FIG. 16 and forward in FIG. 1). FIG. 17 shows the rotation of ball-wheel 10 in a CCW direction to drive the system back or rearward (FIG. 1) and leftward in FIG. 17.

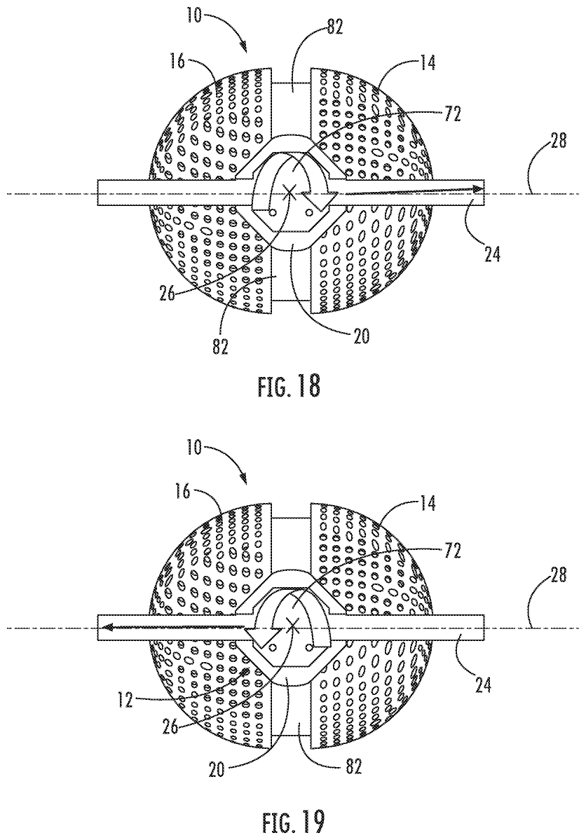

FIGS. 18-19 show a rear plan view of ball-wheel 10. In contrast to FIGS. 16-17, FIGS. 18-19 show longitudinal axis 26 into and out of the page and transverse axis 28 in the plane of the page. FIG. 18 shows ball-wheel 10 rotation in a CW direction to drive the system to the right (FIGS. 1 and 18). In contrast, FIG. 19 shows the same rear plan view rotating in a CCW direction to drive the system left. As will generally be understood, this configuration enables the ball-wheel 10 and drive system 12 to orient and drive a vehicle in any direction.

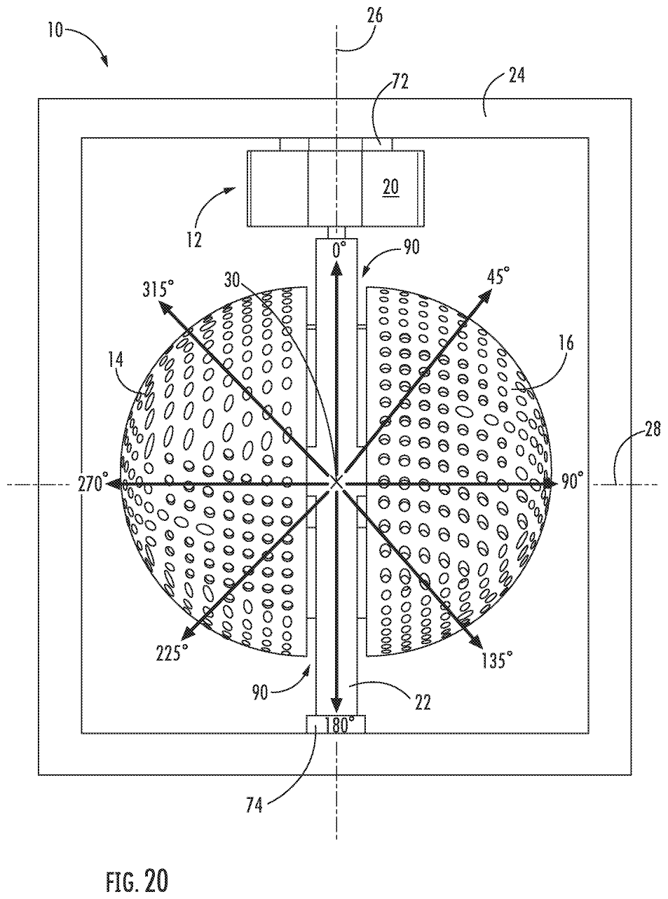

Taken together, FIGS. 16-19 illustrate how controlling rotation about axial or longitudinal axis 26 and spherical or transverse axis 28 (e.g., the speed of rotation about each axis) allows an operator to drive the system in any direction. Coordinating the speed of dependent rotation about longitudinal axis 26 and transverse axis 28 enables the system to translate in any desired direction without turning. FIG. 20 combines FIGS. 16-19 to show how the rotation of spherical caps 14 and 16 shown in FIGS. 16-19 selectively drives ball-wheel 10 in any operator designated direction. Combining direct and/or indirect rotation of spherical caps 14 and 16 translates ball-wheel 10 in a 0°, 45°, 90°, 135°, 180°, 225°, 270°, 315°, or at any other angle.

An operator is enabled to fit and operate the vehicle in a variety of previously foreclosed settings. If the operator wishes to turn the vehicle, coordinated operation of ball-wheels 10 in different directions accomplishes the task. Thus, ball-wheel 10 provides the operator independent control over the direction and the turning operability of the vehicle by providing an additional degree of freedom. In other words, the operator can move the vehicle in any direction with or without turning the vehicle.

Additional descriptions of ball-wheel 10 and drive system 12 as well as vehicles and/or systems that deploy ball-wheels 10 are included in Appendix A.

FIG. 21 is a cross-sectional view of another ball-wheel 10 and drive system 12. In the illustrated embodiment, three motors 20, 60a, and 60b are located on frame 24 external to spherical caps 14 and 16. Independent motors 60a and 60b are coupled to shafts 62a and 62b, respectively. Rotation of output shafts 62a and 62b is transformed to rotate axels 86a and 86b of spherical caps 14 and 16, respectively. For example, output shafts 62a and 62b couple to a bevel gear 88a and 88b to transform the rotation output shaft 62a or 62b rotation to an axel 86a or 86b of spherical cap 14 or 16.

A hollow ball-wheel 10 includes first and second hemispheres 44 (e.g., spherical caps 14 and 16 may be hemispheres 44) each having a base 38 with maximum diameter 40 of great circle 42 passing through center 30. A first base 38 intersects sphere 32 at maximum diameter 40 along great circle 42 to divide sphere 32 into a first half (e.g., hemisphere 14) and a second half (e.g., hemisphere 16). Base 38 defines a plane that separates each hemisphere 14 and 16. Bases 38 are then spaced apart by a small distance or gap 90 for shaft 22. In one embodiment, spherical caps 14 and 16 are not hemispheres 44, but include two spherical caps 14 and 16 with bases 38, e.g., having equal second radii 48.

Spherical ball-wheel 10 includes three motors 20, 60a, and 60b each coupled to an output shaft 22, 62a, and 62b, respectively. A first independent motor 60a is located outside ball-wheel 10 and rotates spherical cap 14 independently about spherical axis 28 relative to spherical cap 16, which is powered by motor 60b. Motor 60a couples to output shaft 62a that rotates within an axial bore 70 (FIG. 11) of rotatable shaft 62a. Output shaft 62 rotates about longitudinal axis 26 within bore 70. A bevel gear 88a converts or transforms rotation of output shaft 62a into rotation of an axle 86a about transverse axis 28. For example, axel 86a rigidly couples to a bushing 58 that rigidly couples axel 86a to spherical cap 14 and independently rotates cap 14 about axis 28.

Similarly, a second independent motor 60b is located on frame 24 outside ball-wheel 10. Motor 60b includes a second output shaft 62b rotating within axial bore 70 of shaft 22 (e.g., on the opposite side of shaft 22). Output shaft 62b rotates about longitudinal axis 26 in bore 70 and couples to bevel gear 88b to rotate axel 86b about transverse axis 28. In one embodiment, bevel gears 88a and 88b are different sizes. For example, bevel gear 88a is larger or smaller than bevel gear 88b to avoid interference with the rotation of bevel gear 88b. Second independent motor 60b is configured to rotate second spherical cap 16 independent of the rotation of spherical cap 14 about transverse axis 28. In other embodiments, bevel gears 88a and 88b are the same or similar size and dependently rotate spherical caps 14 and 16 about transverse axis 28.

In other words, a first motor 60a and a second motor 60b are mounted on frame 24, which surrounds ball-wheel 10 and rotate corresponding output shafts 62a and 62b which couple to bevel gears 88a and 88b to transform the motor 60a and 60b output into rotation about the transverse axis 28. A third or dependent motor 20 is also disposed outside ball-wheel 10 on frame 24 and is configured to turn rotatable shaft 22. As shaft 22 couples to spherical caps 14 and 16, it rotates the spherical caps 14 and 16 dependently about longitudinal axis 26. Ball-wheel 10 includes a protective bracket 80 and/or spring-loaded protective bracket 82 between the first and second halves of spherical caps 14 and 16. Ball-wheel 10 can also include a seal 66 (e.g., on either spherical cap 14 or 16). For example, a first seal 66 is coupled to the first base 38 of spherical cap 14 (e.g., the first half) and a second seal 66 coupled to the second base 38 of spherical cap 16 (e.g., the second half).

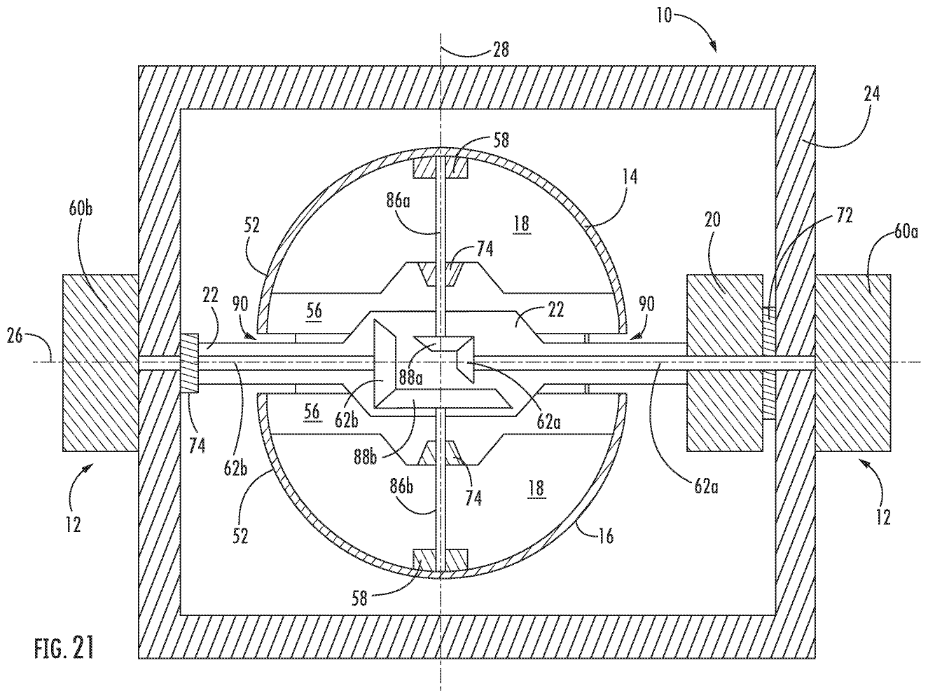

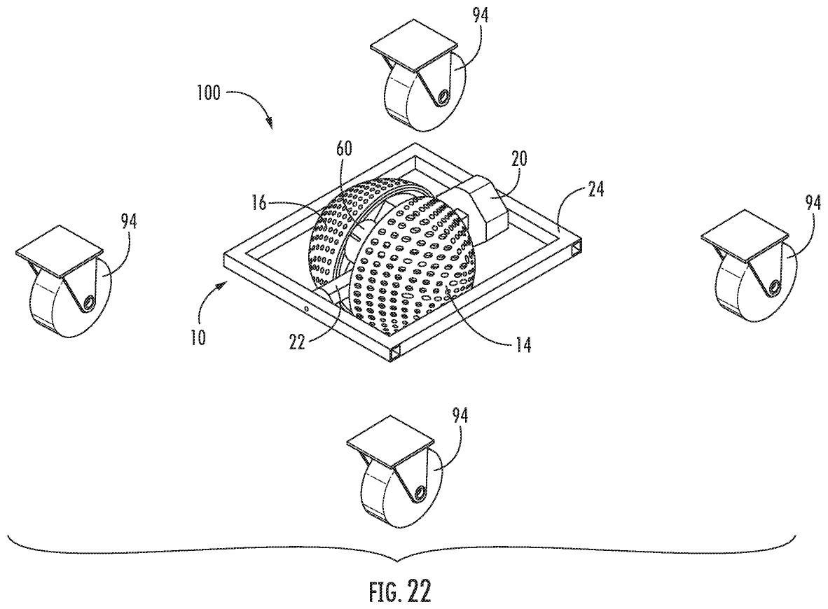

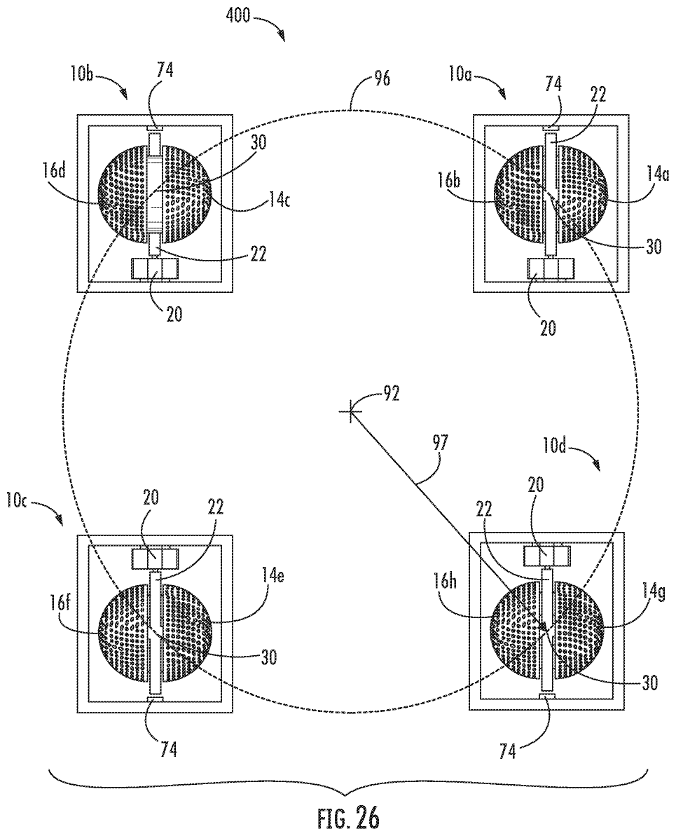

FIG. 22 shows a single ball-wheel 10 system 100 for a vehicle. In this configuration, a ball-wheel 10 and drive system 12 are located at the system center point 92 (FIG. 26) of system 100, and a plurality of casters 94 surround the central ball-wheel 10 and drive system 12. The single ball-wheel 10 system 100 uses additional supports and/or wheeled components such as casters 94. Casters 94 provide stability to the ball-wheel 10 system 100. In some In this configuration, casters 94 are used to steer the vehicle, such that each caster 94 is controlled by the operator to turn or drive system 100 in any desired direction. A vehicle couples to frame 24 of ball-wheel 10 and ball-wheel 10 provides power to the vehicle. Casters 94 provide additional support. Casters 94 are configured with a rank angle that enables the caster 94 to rotate and support the vehicle. Casters 94 and/or ball-wheel 10 are load rated to support the vehicles weight and any additional loads that may be applied to system 100.

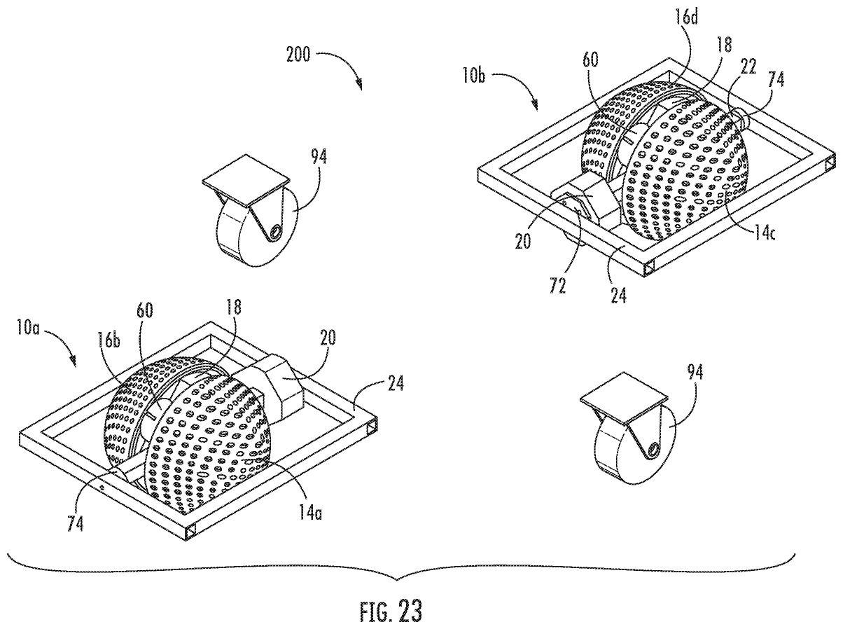

FIG. 23 shows a perspective view of a two ball-wheel 10 vehicle system 200. As shown in FIG. 23 casters 94 provide additional stability to two ball-wheel 10 system 200 uses fewer casters 94 compared to the single ball-wheel system 100 of FIG. 22. In this configuration, two ball-wheel system 200 has two ball-wheels 10 and two or more supporting casters 94. One function of castors 94 is to support the two ball-wheel system 200. In various embodiments, casters 94 may freely rotate or may be controlled by the operator (e.g., to steer the vehicle). For example, a first ball-wheel 10 may operate in one direction while the second ball-wheel 10 operates in a second direction to turn the vehicle with a two ball-wheel system 200. Similarly, two ball-wheels 10 may operate together (e.g., dependently), to turn system 200. In other embodiments, the operator controls casters 94 and/or the first and second ball-wheels 10 to steer the vehicle. In this way, two ball-wheel system 200 enables the operator to translate and/or turn (e.g., rotate) system 200 in any desired direction.

Internal motor 60 may be a single motor 60 or include two motors 60a and 60b that independently drive spherical caps 14 and 16. As the number of ball-wheels 10 increases internal motor 60 can include a single motor 60 with two output shafts 62a and 62b. Also, the increased number of ball-wheels 10 increases traction distributed over ball-wheels 10 and enhances the stability of the vehicle based on the coordination of the ball-wheels 10.

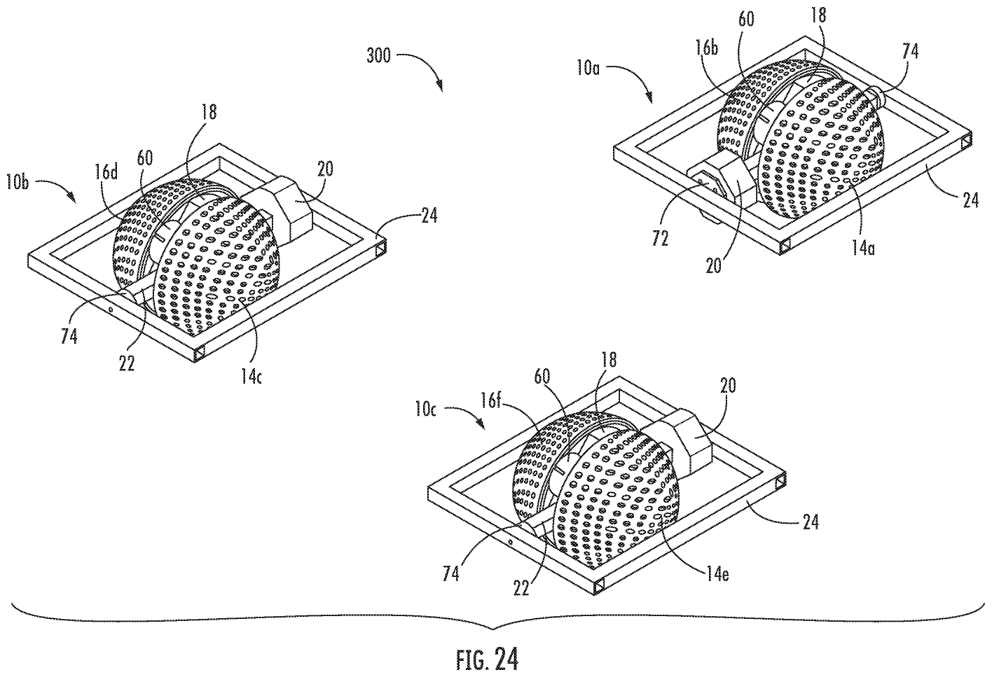

FIG. 24 illustrates a three ball-wheel 10 system 300 with three ball-wheels 10 oriented radially from a central location or center point 92 (FIG. 26). For example, center 30 of each ball-wheel 10 in system 300 is located on a system circle 96 with a vehicle system radius 97 extending from a center point 92 of vehicle chassis 98 (see, e.g., FIGS. 26 and 27). Since each ball-wheel 10 in system 300 can operate independently, the operator is free to translate or turn system 300 in any direction. The additional ball-wheels 10 change the weight rating and enhances support for heavier and/or dynamic loads and enhance traction and stability. Three ball-wheel system 300 eliminates casters 94 by spacing each ball-wheel 10 radially from a center point 92 (FIG. 26) centrally located on chassis 98. For example, the center point 92 of three ball-wheel system 300 may be located at the systems center of gravity (CG). In other embodiments, casters 94 are used to stabilize system 300.

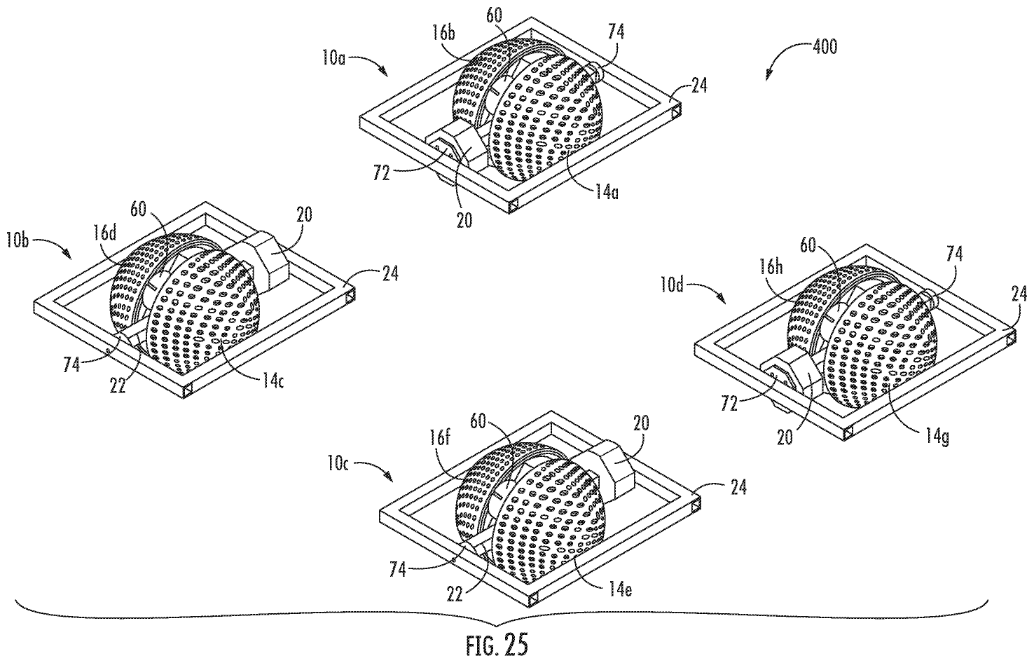

FIG. 25 shows a perspective view of a four-ball-wheel system 400. FIG. 26 is a top view of the four-ball-wheel system 400 with a system circle 96 having system radius 97 that passes from system center point 92 (FIG. 26) through a center 30 of all four ball-wheels 10.

Similar configurations with vehicle system radii for a 3, 4, 5, 6, 7, 8, or more ball-wheel system are envisioned. Regarding FIGS. 23-25, each ball-wheel 10 in a multi-ball-wheel 10 assembly (e.g., 200, 300, or 400) uses a control algorithm to control each ball-wheel 10 within the system. The same or similar control algorithm is implemented for every ball-wheel 10. This algorithm is facilitated by locating each ball-wheel 10 an equal distance or vehicle system radius 97 from system center point 92 (see FIG. 26). This configuration enables the system to use the same or similar control algorithm software for each ball-wheel 10 without using a unique algorithm to control each ball-wheel 10 in the system individually.

With reference to FIG. 26, each ball-wheel 10 has a pair of spherical caps 14 and 16. For example, a first ball-wheel 10a includes first and second spherical caps 14a and 16a, a second ball-wheel 10b includes third and fourth spherical caps 14b and 16b, and a third ball-wheel 10c includes fifth and sixth spherical caps 14c and 16c. A fourth ball-wheel 10d includes seventh and eighth spherical caps 14d and 16d coupled at a fourth center 30d of spherical caps 14d and 16d. The seventh and eighth spherical caps 14d and 16d dependently rotate about a fourth longitudinal axis 26 and rotate independently about a fourth transverse axis 28 perpendicular to the fourth longitudinal axis 26. The transverse axis 28 passes through a seventh pole 36d of the seventh spherical cap 14d and an eighth pole 36d of the eighth spherical cap 16d. The first, second, third, and fourth centers 30 each correspond to a ball-wheel 10 located in a circular formation on system circle 96. The vehicle system radius 97 begins at a vehicle center 92 and passes through a center 30 of each ball-wheel 10.

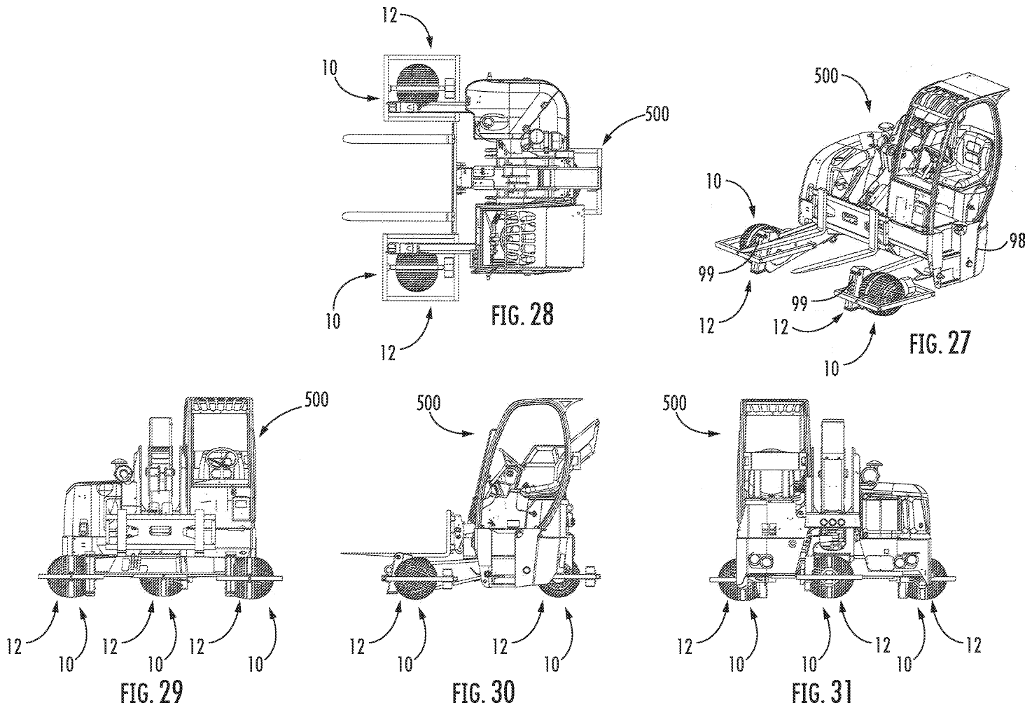

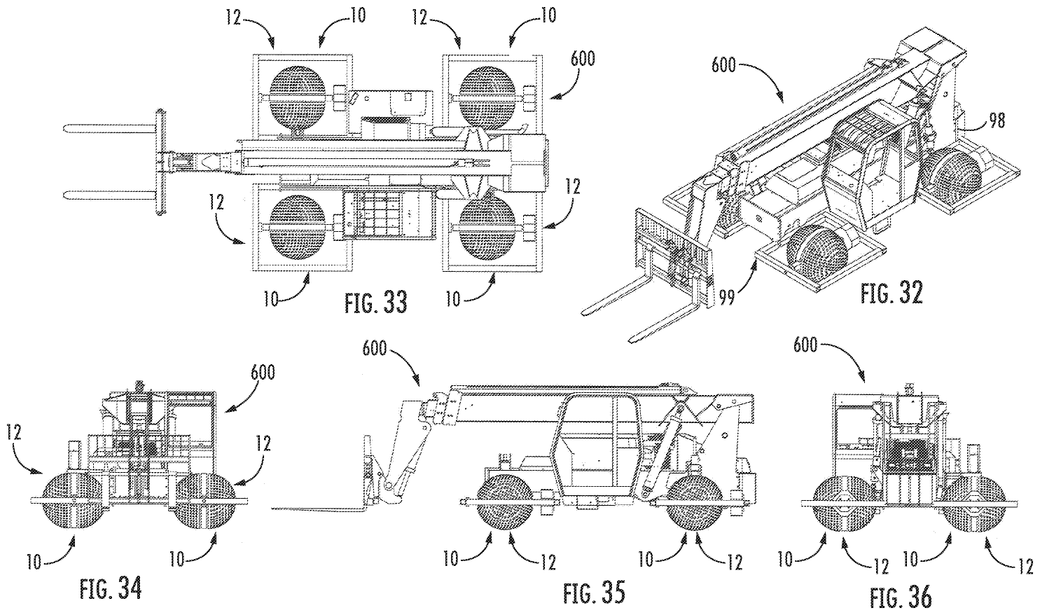

FIGS. 27-36 show various embodiments and features of ball-wheel 10 systems implementing a three ball-wheel vehicle 500 (FIGS. 27-31) and a four-ball-wheel vehicle 600 (FIGS. 32-36), according to various exemplary embodiments. As shown, three ball-wheel vehicle 500 is a forklift, and four-ball-wheel vehicle 600 is a telehandler, but other configurations can be used with three and four-ball-wheel vehicles 500 and 600. For example, similar ball-wheel 10 systems can be used on skid steers, articulated loaders, telehandlers, man-lifts, utility vehicles, powered wheel-chairs, lawn mowers (riding or walk-behinds), Automated Guided Vehicles (AGVs), Robots, unmanned vehicles, etc. Ball-wheel 10 systems enhance move-ability by allowing translation and/or rotation of the system in any direction. As illustrated in FIGS. 27-36, each ball-wheel 10 includes a drive system 12 and is controlled with dependent motor 20 and independent and/or dependent motor(s) 60. A steering system for vehicles 500 and 600 controls the cooperation of individual ball-wheels 10. For example, two ball-wheels 10 may rotate in the same or opposite directions based on feedback from the steering controls.

For convenience only, the following description refers to vehicle 500, but it should be understood that the description applies equally to vehicle 600 and/or assemblies 100, 200, 300, and/or 400. Vehicle 500 includes three or more ball-wheels 10 (e.g., vehicle 600 includes four or more ball-wheels 10). Each ball-wheel 10 includes a first spherical cap 14 coupled to a second spherical cap 16. A point between the spherical caps 14 and 16 forms a center 30 of each ball-wheel 10. In this way, the first and second spherical caps 14 and 16, of each ball-wheel 10, dependently rotate about longitudinal axis 26. Also, the spherical caps 14 and 16 are configured to rotate independently about transverse axis 28 that is perpendicular to longitudinal axis 26 and passes through a first pole 36 of first spherical cap 14 and a second pole 36 of second spherical cap 16. In some configurations, first center 30a of first ball-wheel 10a, second center 30b of second ball-wheel 10b, and third center 30c of third ball-wheel 10c are each located on a system circle 96 such that a vehicle system radius 97 of system circle 96 passes through first center 30a, second center 30b, and third center 30c.

In some ball-wheel 10 systems, rotating casters 94 independently support a vehicle 500 chassis 98. Shock absorption damper springs 99 between frame 24 and vehicle 500 chassis 98 and/or damper springs 99 between the first, second, third, and/or fourth ball-wheels 10, reduces impact loads on ball-wheel 10 and enhances operator experience while operating vehicle 500. For example, an absorption damper spring 99 is coupled to frame 24 to deflect and/or absorb impact forces distributed to ball-wheel 10. The first, second, third, and/or fourth ball-wheels 10 may also include a tractive exterior 52, such that the vehicle is configured to operate on rugged terrain. In another embodiment, the outer sphere is a tractive material configured to operate on smooth terrain (e.g., a shop floor or level concrete).

It should be understood that the figures illustrate the exemplary embodiments in detail, and it should be understood that the present application is not limited to the details or methodology set forth in the description or illustrated in the figures. It should also be understood that the terminology is for description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions, and arrangement of the various exemplary embodiments without departing from the scope of the present invention.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

In various exemplary embodiments, the relative dimensions, including angles, lengths, and radii, as shown in the Figures, are to scale. Actual measurements of the Figures will disclose relative dimensions, angles, and proportions of the various exemplary embodiments. Various exemplary embodiments extend to various ranges around the absolute and relative dimensions, angles, and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A ball-wheel and wheel drive system comprising:
a first spherical cap comprising:
a first pole on the first spherical cap;
a first base of the first spherical cap including a first center opposite the first pole;
a first motor coupled to the first center and configured to rotate the first spherical cap; and
a second spherical cap comprising:
a second pole on the second spherical cap;
a second base of the second spherical cap including a second center opposite the second pole, the second base of the second spherical cap being parallel and opposite the first base of the first spherical cap to form a spherical zone, wherein a spherical axis is defined through the first pole and the second pole; and
a second motor coupled to the second center and configured to rotate the second spherical cap;
a shaft coupled to the first center and the second center, the shaft defining an axial axis; wherein the first motor is configured to rotate the first spherical cap about the spherical axis independently from the second motor that is configured to rotate the second spherical cap about the spherical axis; and
a third motor coupled to the shaft, wherein the third motor rotates the first spherical cap and the second spherical cap dependently about the axial axis.

2. The system of claim 1, wherein the first motor is mounted within the first spherical cap, the second motor is mounted within the second spherical cap, and the third motor is mounted on the axial axis outside the first spherical cap and the second spherical cap.

3. The system of claim 1, further comprising a tractive sphere cap coupled to an inner sphere cap, wherein the tractive sphere cap comprises a resilient material including formations to provide traction, and the inner sphere cap comprises a rigid material.

4. The system of claim 1, wherein the first spherical cap and second spherical cap are hemispheres.

5. The system of claim 1, further comprising a protective bracket between the first spherical cap and the second spherical cap.

6. The system of claim 1, further comprising a first seal coupled to the first base of the first spherical cap and a second seal coupled to the second base of the second spherical cap.

7. The system of claim 1, further comprising a first inner support bracket and a second inner support bracket, wherein the first inner support bracket couples the first sphere cap to the first motor and the second inner support bracket couples the second sphere cap to the second motor.

8. The system of claim 1, further comprising a frame coupled to the shaft, the first spherical cap, second spherical cap, and the shaft is rotatably coupled to the frame.

9. The system of claim 1, wherein the first motor is located within the first spherical cap and the second motor is located within the second spherical cap, wherein the first motor and the second motor are centrally located on the shaft from the first center and the second center.

10. A two-axis ball-wheel and drive system comprising:
a hollow, spherical wheel including first and second equal halves each having a maximum diameter, wherein the maximum diameters are equal, and each has a center, a first plane intersects the first half at the maximum diameter of the first half, a second plane intersects the second half at the maximum diameter of the second half, and a distance spaces the first and second planes;
a longitudinal axis perpendicular to the first and second planes and intersecting the first and second planes at the centers;
a transverse axis that intersects the longitudinal axis between the first and second planes;
a rotatable shaft comprising an axial bore, the shaft and the bore extending along the longitudinal axis;
a first motor with an output shaft rotating within the axial bore of the rotatable shaft about the longitudinal axis, rotation of the output shaft being transformed into rotation about the transverse axis, the first motor configured to rotate the first half about the transverse axis;
a second motor with an output shaft rotating within the axial bore of the rotatable shaft about the longitudinal axis, rotation of the output shaft being transformed into rotation about the transverse axis, the second motor configured to rotate the second half about the transverse axis independent of the rotation of the second half about the transverse axis; and
a third motor configured to rotate the rotatable shaft and rotate the first half and the second half dependently about the longitudinal axis.

11. The system of claim 10, wherein the first motor and the second motor are mounted on a frame surrounding the spherical wheel, the output shafts of the first motor and the second motor rotating about the longitudinal axis within the axial bore of the rotatable shaft and being transformed to rotate the first half and the second half independently about the transverse axis, wherein the third motor is mounted on the frame and configured to rotate the rotatable shaft about the longitudinal axis and surrounding the output shafts of the first and second motors.

12. The system of claim 10, further comprising a protective bracket between the first half and the second half, a first seal coupled to a first base of the first half, and a second seal coupled to a second base of the second half.

13. The system of claim 10, further comprising a frame surrounding a two-axis spherical wheel and an absorption damper coupled to the frame, wherein the absorption damper is coupled to the frame, the absorption damper deflecting to absorb impact forces distributed to the two-axis spherical wheel.

14. The system of claim 10, further comprising a first bevel gear coupling the output shaft of the first motor to the first half, and a second bevel gear coupling the output shaft of the second motor to the second half.

15. The system of claim 10, wherein the first half comprises a rigid inner layer and an outer traction layer, and the second half comprises a rigid inner layer and an outer traction layer.

16. The system of claim 15, wherein the outer traction layer comprises holes permeating through the outer traction layer.

17. A vehicle comprising:
a first ball-wheel comprising a first spherical cap coupled to a second spherical cap at a first center of the first and second spherical caps, the first and second spherical caps dependently rotate about a first longitudinal axis and configured to rotate independently about a first transverse axis that is perpendicular to the first longitudinal axis and passes through a first pole of the first spherical cap and a second pole of the second spherical cap;
a second ball-wheel comprising a third spherical cap coupled to a fourth spherical cap at a second center of the third and fourth spherical caps, the third and fourth spherical caps dependently rotate about a second longitudinal axis and configured to rotate independently about a second transverse axis that is perpendicular to the second longitudinal axis and passes through a third pole of the third spherical cap and a fourth pole of the fourth spherical cap; and
a third ball-wheel comprising a fifth spherical cap coupled to a sixth spherical cap at a third center of the fifth and sixth spherical caps, the fifth and sixth spherical caps dependently rotate about a third longitudinal axis and configured to rotate independently about a third transverse axis that is perpendicular to the third longitudinal axis and passes through a fifth pole of the fifth spherical cap and a sixth pole of the sixth spherical cap;
wherein the first center of the first and second spherical caps, the second center of the third and fourth spherical caps, and the third center of the fifth and sixth spherical caps are located on a circle such that a diameter of the circle passes through the first center of the first and second spherical caps, the second center of the third and fourth spherical caps, and the third center of the fifth and sixth spherical caps.

18. The vehicle of claim 17, further comprising a fourth ball-wheel comprising a seventh spherical cap coupled to an eighth spherical cap at a fourth center of the seventh and eighth spherical caps, the seventh and eighth spherical caps dependently rotate about a fourth longitudinal axis and configured to rotate independently about a fourth transverse axis that is perpendicular to the fourth longitudinal axis and passes through a seventh pole of the seventh spherical cap and an eighth hole of the eighth spherical cap; wherein the first center of the first and second spherical caps, the second center of the third and fourth spherical caps, the third center of the fifth and sixth spherical caps, and the fourth center of the seventh and eighth spherical caps are located in the circle such that the diameter of the circle passes through the first center, the second center, the third center, and the fourth center.

19. The vehicle of claim 17, further comprising rotating casters that independently support a chassis of the vehicle.

20. The vehicle of claim 17, further comprising shock absorption dampers between the first ball-wheel and a chassis, the second ball-wheel, and the chassis, and the third ball-wheel and the chassis, wherein the first ball-wheel, the second ball-wheel, and the third ball-wheel include a tractive outer sphere, such that the vehicle is configured to operate on rugged terrain.
